(19) United States
(12) Patent Application Publication
(10) Pub. No.: US 2022/0282471 A1
(43) Pub. Date: Sep. 8, 2022

(54) STORM WATER DRAIN PIT

(71) Applicant: ROCKWOOL B.V., Roermond (NL)

(72) Inventors: Rutgerus Nicolaas Pieter Maria VAN DER VELD, Hedehusene (DK); Robertus Lambertus Maria DRIESSEN, Hedehusene (DK); Wilhelmus Lambertus Johannes PETERS, Hedehusene (DK)

(73) Assignee: ROCKWOOL B.V., Roermond (NL)

(21) Appl. No.: 17/632,479

(22) PCT Filed: Aug. 13, 2020
(86) PCT No.: PCT/EP2020/072735

§ 371 Date: Feb. 2, 2022

(30) Foreign Application Priority Data
Aug. 13, 2019 (EP) 19191579.2

(51) Int. Cl. E03F 5/04; C02F 1/00; B01D 29/25; B01D 29/90; B01D 39/20; B01D 35/30; B01D 21/00

(52) U.S. Cl. CPC E03F 5/0404; E03F 5/0403; C02F 1/001; B01D 29/25; B01D 29/902; B01D 39/2089; B01D 35/30; B01D 21/0012; B01D 21/0006; C02F 2103/001

(57) ABSTRACT

The invention relates to a storm water drain pit comprising: an inlet for storm water; a filter for removing particles from the storm water, comprising a cylindrical body comprising coherent man-made vitreous fibres (MMVF) bonded with a cured binder composition; wherein the cylindrical body has a hollow centre and an outer wall; a guide element for guiding water from the inlet into the cylindrical body; a sedimentation chamber for sedimentation of particles from the storm water, wherein the cylindrical body is positioned below the inlet and above the sedimentation chamber; an outlet for filtered water; wherein the outlet is positioned above the sedimentation chamber and below the inlet; and a separation element for separating the sedimentation chamber from the outlet; wherein the cylindrical body has a density in the range of 50 to 200 kg/m³, a binder content in the range of 2 to 5 wt % and the outer wall has a circumferential thickness in the range of 2 cm to 20 cm.

### FIELD OF THE INVENTION

This invention relates to a storm water drain pit comprising a filter, a method of making a filter, a method of installing a filter into a storm water drain pit, a filter for a storm water drain pit and use of a filter in a storm water drain pit.

### BACKGROUND OF THE INVENTION

Storm water (e.g. run off water from residential and commercial areas) is collected and transported by storm water drain systems. Typically, the storm water is channeled into the storm water system via storm water drain pits i.e. storm water drains in the ground, also called storm water gullies, catch basins or storm water inlets. Storm water drain systems typically have a number of storm water drain pits, which lead to a network of underground drain pipes. The storm water is collected by the storm water drain pits, filtered to remove particulates or debris and then transported to a water storage area.

It is desirable to collect the particulates, pollutants and debris at the initial point of entry into the storm water drain system i.e. in the storm water drain pit. This is because it is necessary for the particulates, pollutants and debris, which have been removed via filtration, to be removed periodically from the drain system in order to prevent blockage of the drainage and filtering system. Typically, in order for the collection of particulates, pollutants and debris to be removed, it is necessary for an individual (e.g. a maintenance worker) to first remove the filter. This can be time-consuming as the storm water drain pit must be, in part, dismantled and then rebuilt.

The filters in storm water drain pits must be able to remove large amounts of particulates, pollutants and debris from storm water. They must also be easily serviced and maintained, as it is necessary to remove the filtered debris periodically. Furthermore, the filters must be capable of being held securely in place within the storm water drain pit, so as not to be dislodged by heavy flows of storm water.

US 2014/0374332 A1 discloses a filtration apparatus for removing particulates and contaminants from storm water run-off. The filtration apparatus comprises a collapsible frame for supporting a filter bag. The filter bag may be formed of a mesh, such as glass fibre mesh.

U.S. Pat. No. 6,093,314 A discloses a drain insert for a storm water sewer system which prevents sand, gravel and petroleum products from entering the storm water removal system. The drain insert comprises a filter element which is formed of geotextile material and is supported by a pair of hooks. In order for debris which has been collected to be removed, the entire drain insert is removed from the storm water sewer system.

U.S. Pat. No. 6,517,709 B1 discloses a filter assembly for a catch basin erosion containment. The filter assembly contains a rigid frame and a containment bag formed of woven and non-woven geotextile fabric.

US 2009/0173699 A1 discloses a filter for a storm drain system. The filter is made of flexible material and is configured to be suspended within a catch basin, so that it is easy to install and remove for cleaning.

US 2009/0045128 A1 discloses an elongated filterable element used for removing sediment in storm water. The filtering element contains a support member, a filter mat, which can be made of fibreglass fibres, and an outer casing.

US 2009/0277820 A1 discloses a filtering device for storm water run-off. It contains a removable frame and a filtering component, which may be made from fiberglass.

It would be desirable to produce a filter for a storm water drain pit which is self-supporting and rigid. It would be desirable to produce a filter for a storm water drain pit which does not need to be removed when the storm water drain pit is being cleaned i.e. when the collected debris is removed by a storm water drain pit emptier or sludge exhauster. It would be desirable to produce a filter for a storm water drain pit which has a longer life span than existing filters. It would be desirable to produce a filtering system for a storm water drain pit which has equivalent or improved filtration in comparison to existing filtering systems i.e. can remove the same or more pollutants, contaminants, particulates and debris, while also being less likely to get clogged or blocked. It would be desirable to produce a filter for a storm water drain pit which is hydrophilic. Furthermore, it would be desirable to produce a filter and filter system for a storm water drain pit which is environmentally acceptable and economical in terms of production, installation and use. The present invention solves these problems.

### SUMMARY OF THE INVENTION

In a first aspect of the invention, there is disclosed a storm water drain pit comprising:

an inlet for storm water;
a filter for removing particles from the storm water, comprising a cylindrical body comprising coherent man-made vitreous fibres (MMVF) bonded with a cured binder composition; wherein the cylindrical body has a hollow centre and an outer wall;
a guide element for guiding water from the inlet into the cylindrical body;
a sedimentation chamber for sedimentation of particles from the storm water, wherein the cylindrical body is positioned below the inlet and above the sedimentation chamber;
an outlet for filtered water; wherein the outlet is positioned above the sedimentation chamber and below the inlet; and
a separation element for separating the sedimentation chamber from the outlet;
wherein the cylindrical body has a density in the range of 50 to 200 kg/m³, a binder content in the range of 2 to 5 wt % and the outer wall has a circumferential thickness in the range of 2 cm to 20 cm.

In a second aspect of the invention, there is disclosed a filter for a storm water drain pit, comprising:

a cylindrical body comprising coherent man-made vitreous fibres (MMVF) bonded with a cured binder composition; wherein the cylindrical body has a hollow centre and an outer wall;
wherein the cylindrical body has a density in the range of 50 to 200 kg/m³, a binder content in the range of 2 to 5 wt % and the outer wall has a circumferential thickness in the range of 2 cm to 20 cm.

In a third aspect of the invention, there is disclosed use of a filter for removing particulates from storm water, wherein the filter comprises: a cylindrical body comprising man-made vitreous fibres (MMVF) bonded with a cured binder composition; wherein the cylindrical body has a hollow centre and an outer wall;

wherein the cylindrical body has a density in the range of 50 to 200 kg/m³, a binder content in the range of 2 to 5 wt % and the outer wall has a circumferential thickness in the range of 2 cm to 20 cm.

In a fourth aspect of the invention, there is disclosed a method of

installing a filter into a storm water drain pit, comprising the steps:
inserting a filter into a storm water drain pit; wherein the filter comprises a cylindrical body comprising coherent man-made vitreous fibres (MMVF) bonded with a cured binder composition; wherein the cylindrical body has a hollow centre and an outer wall; wherein the cylindrical body has a density in the range of 50 to 200 kg/m³, a binder content in the range of 2 to 5 wt % and the outer wall has a circumferential thickness in the range of 2 cm to 20 cm.

In a fifth aspect of the invention, there is disclosed a method of emptying a storm water drain pit according to the present invention, comprising the steps:

inserting a storm water drain pit extractor through the inlet and the hollow centre of the cylindrical body, and into the sedimentation chamber; using the storm water drain pit extractor to remove sediment in the sedimentation chamber; and
removing the storm water drain pit extractor from the sedimentation chamber, hollow centre of the cylindrical body and the inlet.

In a sixth aspect of the invention, there is disclosed a storm water drain pit liner comprising:

a housing comprising;
an inlet for storm water;
a filter for removing particles from the storm water, comprising a cylindrical body comprising coherent man-made vitreous fibres (MMVF) bonded with a cured binder composition; wherein the cylindrical body has a hollow centre and an outer wall;
a guide element for guiding water from the inlet into the cylindrical body;
a sedimentation chamber for sedimentation of particles from the storm water, wherein the cylindrical body is positioned below the inlet and above the sedimentation chamber;
an outlet for filtered water; wherein the outlet is positioned above the sedimentation chamber and below the inlet; and
a separation element for separating the sedimentation chamber from the outlet; wherein the cylindrical body has a density in the range of 50 to 200 kg/m³, a binder content in the range of 2 to 5 wt % and the outer wall has a circumferential thickness in the range of 2 cm to 20 cm.

### BRIEF DESCRIPTION OF FIGURES

FIG. 1 shows a filter for a storm water drain pit according to the present invention.

FIG. 2 shows a storm water drain pit according to the present invention.

FIG. 3 shows the results of water permeability tests.

### DETAILED DESCRIPTION

The invention relates to a storm water drain pit comprising an inlet for storm water; a filter; a sedimentation chamber and an outlet for filtered water. A storm water drain pit is an underground drain system in which storm water is filtered and channeled into the storm water system. The filtered water is transported to a water collection point. Storm water drain pits are also called storm water drains in the ground, gullies, catch basins or storm water inlets. Typically a storm water drain pit is reached via a permeable grid in the ground i.e. a gridded drain cover. A storm water drain system typically includes multiple storm water drain pits.

The filter according to the present invention comprises a cylindrical body. The term cylindrical has its usual meaning in the art i.e. shaped like a cylinder. It has an upper circular face and a lower circular face and an outer wall which joins the upper circular face to a lower circular face. The cylindrical body has a circular cross-section. The cylindrical body has a hollow centre. By this, it is meant that the cylindrical body has a hollow section which extends from the upper circular face to the lower circular face. The cylindrical body having a hollow centre is pipe-shaped. The cylindrical body has an outer diameter, an inner diameter and a circumferential thickness, due to the hollow centre. The advantage of a filter comprising a cylindrical body with a hollow centre is that it does not need to be removed during maintenance and cleaning of the storm water drain pit. Advantageously, the pipes/vacuums used for removing debris from storm water drain pits can be inserted through the hollow centre of the filter. Due to the pipe-shaped filter of the present invention, the storm water drain pit can be cleaned without the need to remove the filter. This means that maintenance and cleaning are more efficient and less time-consuming.

The cylindrical body of the filter comprises coherent man-made vitreous fibres (MMVF) bonded with a cured binder composition. The man-made vitreous fibres (MMVF) can be glass fibres, ceramic fibres, basalt fibres, slag wool, stone wool and others, but are usually stone wool fibres. Stone wool generally has a content of iron oxide at least 3% and content of alkaline earth metals (calcium oxide and magnesium oxide) from 10 to 40%, along with the other usual oxide constituents of MMVF. These are silica; alumina; alkali metals (sodium oxide and potassium oxide) which are usually present in low amounts; and can also include titania and other minor oxides. Fibre diameter is often in the range of 3 to 20 μm, preferably 3 to 5 μm.

The filter according to the present invention is preferably in the form of a coherent mass of MMVF i.e. a MMVF substrate. That is, the filter is generally a coherent matrix of MMVF fibres bonded with a cured binder composition, which has been produced as such, or has been formed by granulating a slab of MMVF and consolidating the granulated material.

The filter according to the present invention comprises a cylindrical body that is self-supporting in use. By this, it is meant that the cylindrical body is rigid and capable of staying upright or in position without the use of a support. The filter according to the present invention is upright in use, by this it is meant that the lower circular face is positioned on a surface, and the upper circular face is exposed. Storm water to be filtered passes through hollow centre of the cylindrical body, via the upper circular face, and is filtered to remove particulates.

The storm water passes through the side walls of the cylindrical body but particulates are prevented from passing through the side walls. The cylindrical body is rigid and self-supporting due to the binder content, density of the MMVF, and circumferential thickness of the outer wall. This is discussed in more detail below. The rigidity can be defined as a range of water pressure the cylindrical body can withstand. Preferably, the hollow centre of the cylindrical body can withstand being fully filled with water, with no water at the circumference of the filter. Preferably, the cyclindrical body can withstand pressures of up to 0.1 atm, more preferably up to 0.5 atm. In such an embodiment, the water pressure is equivalent to the height of the cylindrical body.

The filter according to the present invention comprises man-made vitreous fibres bonded with a binder. The binder is present in the range of 2 to 5 wt %, preferably 3 to 4 wt %. This ensures that the filter according to the present invention is rigid and self-supporting in the sense that it can remain upright when positioned in use.

The binder can be an organic hydrophobic binder, and in particular it can be a conventional heat-curable (thermosetting), binder of the type which has been used for many years in MMVF substrates (and other MMVF-based products). This has the advantage of convenience and economy. Thus, the binder is preferably a phenol formaldehyde resin or urea formaldehyde resin, in particular phenol urea formaldehyde (PUF) resin.

The binder may be a formaldehyde-free aqueous binder composition comprising: a binder component (A) obtainable by reacting at least one alkanolamine with at least one carboxylic anhydride and, optionally, treating the reaction product with a base; and a binder component (B) which comprises at least one carbohydrate, as disclosed in WO2004/007615. Binders of this type are hydrophilic. WO97/07664 discloses a hydrophilic substrate that obtains its hydrophilic properties from the use of a furan resin as a binder. Binders of this type may be used in the present invention.

WO07129202 discloses a hydrophilic curable aqueous composition wherein said curable aqueous composition is formed in a process comprising combining the following components:

(a) a hydroxy-containing polymer,

(b) a multi-functional crosslinking agent which is at least one selected from the group consisting of a polyacid, salt(s) thereof and an anhydride, and

(c) a hydrophilic modifier;

wherein the ratio of (a):(b) is from 95:5 to about 35:65.

The hydrophilic modifier can be a sugar alcohol, monosaccharide, disaccharide or oligosaccharide. Examples given include glycerol, sorbitol, glucose, fructose, sucrose, maltose, lactose, glucose syrup and fructose syrup. Binders of this type can be used in the present invention.

Further, a binder composition comprising:
a) a sugar component, and
b) a reaction product of a polycarboxylic acid component and an alkanolamine component,

wherein the binder composition prior to curing contains at least 42% by weight of the sugar component based on the total weight (dry matter) of the binder components may be used in the present invention.

The binder may be as described in WO 2017/114724, wherein the binder composition prior to curing comprises the following components:

a component (i) in the form of one or more compounds selected from
compounds of the formula, and any salts thereof:

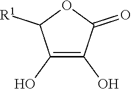

in which R1 corresponds to H, alkyl, monohydroxyalkyl, dihydroxyalkyl, polyhydroxyalkyl, alkylene, alkoxy, amine;
compounds of the formula, and any salts thereof:

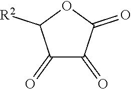

in which R2 corresponds to H, alkyl, monohydroxyalkyl, dihydroxyalkyl, polyhydroxyalkyl, alkylene, alkoxy, amine;
a component (ii) in the form of one or more compounds selected from the group of ammonia, amines or any salts thereof;
a component (iii) in the form of one or more carbohydrates.

The binder composition may be as described in WO 2017/114723 wherein the binder composition prior to curing comprises the following components:
a component (i) in form of one or more carbohydrates;
a component (ii) in form of one or more compounds selected from sulfamic acid, derivatives of sulfamic acid or any salt thereof.

The binder composition may be a composition comprising at least on hydrocolloid prior to curing. Preferably, the at least one hydrocolloid is selected from the group consisting of gelatin, pectin, starch, alginate, agar agar, carrageenan, gellan gum, guar gum, gum arabic, locust bean gum, xanthan gum, cellulose derivatives such as carboxymethylcellulose, arabinoxylan, cellulose, curdlan, β-glucan.

The filter according to the present invention comprises a cylindrical body having a density in the range of 50 to 200 kg/m³, preferably 100 to 160 kg/m³. The advantage of this is that it ensures that the filter according to the present invention is rigid and self-supporting in the sense that it can remain upright when positioned in use. Furthermore, this density range ensures that the filter has sufficient strength whilst also having sufficient filtering capacity i.e. the speed at which water can pass through the MMVF filter. If the density is too high, the filter will be strong but will have a lower filtering capacity. Equally, if the density is too low, the filter will not have sufficient strength during use.

The filter according to the present invention has an outer wall with a circumferential thickness in the range of 1 cm to 20 cm, preferably 1 cm to 10 cm, more preferably 1 to 5 cm. This ensures that the filter according to the present invention is rigid and self-supporting in the sense that it can remain upright when positioned in use.

Preferably, the filter according to the present invention comprises a cylindrical body having an outer diameter in the range of 5 to 35 cm, preferably 15 to 25 cm, most preferably 19 to 23 mm. The advantage of this is that it allows traditional cleaning and maintenance equipment to pass through the hollow centre of the cylindrical body. A further advantage is that the surface area of the filter is increased, which improves the filtering capacity.

Preferably, the filter according to the present invention comprises a cylindrical body having an inner diameter in the range of 3 to 25 cm, preferably 10 to 22 cm, most preferably 14 to 16 cm. The advantage of this is that it allows traditional cleaning and maintenance equipment to pass through the hollow centre of the cylindrical body.

Preferably, the filter according to the present invention comprises a cylindrical body having a surface area in the range of 500 to 3,000 cm², preferably 750 to 2,750 cm², most preferably 1,250 to 2,500 cm². This ensures that the filter has sufficient surface area to filter large amounts of storm water.

Preferably, the filter according to the present invention comprises a cylindrical body having a length 15 to 55 cm, preferably 20 to 50 cm, most preferably 25 to 45 cm. The term length means the longest dimension in the filter i.e. the distance from the lower circular face to the upper circular face. This ensures that the filter fits into standard storm water drain pits. Preferably, the filter according to the present invention comprises a cylindrical body which is hydrophilic, that is, it attracts water. Hydrophilic has its normal meaning in the art. An advantage of the cylindrical body being hydrophilic is that water passes through the filter at a high speed, increasing the filtration capacity of the filter. In a preferred embodiment, the rate of flow of water is up to 1 litre per second.

The hydrophilicity of a sample of MMVF substrate can be measured by determining the sinking time of a sample. A sample of MMVF substrate having dimensions of 100×100×15 mm to 100×100×100 mm is required for determining the sinking time. A container with a minimum size of 200×200×200 mm is filled with water. The sinking time is the time from when the sample first contacts the water surface to the time when the test specimen is completely submerged. The sample is placed in contact with the water in such a way that a cross-section of 100×100 mm first touches the water. The sample will then need to sink a distance of just over the height of the sample in order to be completely submerged. The faster the sample sinks, the more hydrophilic the sample is. The MMVF substrate is considered hydrophilic if the sinking time is less than 240 s. Preferably the sinking time is less than 100 s, more preferably less than 60 s, most preferably 50 s. In practice, the MMVF substrate may have a sinking time of 50 s or less.

Preferably, the filter according to the present invention comprises a cylindrical body which is free from oil or substantially free from oil. Preferably, the cylindrical body is substantially free from oil. By this, it is meant that the further coherent layer comprises less than 1 wt % oil, preferably less than 0.5 wt % of oil. Most preferably the cylindrical body is free from oil. By this it is meant that the further coherent layer has 0 wt % of oil. Oil is typically added to MMVF substrates which are to be used for purposes such as sound, insulation, thermal insulation and fire protection. However, the inventors have surprisingly discovered that the cylindrical body is sufficiently hydrophilic to absorb and drain water when it is free from oil or substantially free from oil. In this embodiment, the binder composition may be hydrophilic or hydrophobic, as discussed above. Preferably, when the binder composition is hydrophobic, the coherent plate is free from or substantially free from oil.

The inlet in the storm water drain pit according to the present invention is for entry of the storm water to be filtered. Preferably, the inlet is an aperture in the ground. The inlet may be any shape i.e. circular, square, rectangular. Preferably, the inlet is circular i.e. a circular hole in the ground leading to the storm water drain pit. The cylindrical body is positioned below the inlet.

The storm water drain pit according to the present invention comprises a guide element for guiding water from the inlet into the cylindrical body. Preferably the guide element prevents water entering the storm water drain pit from flowing anywhere but through the hollow centre of the cylindrical body. Preferably the guide element extends across the entire cross section of the storm water drain pit and has an aperture which overlaps i.e. is positioned above the upper circular face of the cylindrical body. In this way, the guide element acts as a funnel for water entering the storm water drain pit.

Preferably the inlet is covered with a lid. Preferably the lid is hinged such that it can be opened and closed. This is also known as a drain cover. Preferably the lid is a grid i.e. a cover with perforations. Storm water flows along gutters on the road or pavement, and enters the storm water drain pit, which is underground, via the inlet. Therefore, the lid is permeable to allow water to pass through the inlet. The lid can be any dimension suitable for covering the inlet. For example, the lid may be 200 to 300 cm by 200 to 300 cm.

Preferably, in use, storm water flows through the inlet and into the hollow centre of the cylindrical body of the filter. Preferably, the inlet is positioned directly above the upper circular face of the cylindrical body. Water flows through the hollow centre and passes through the outer wall of the cylindrical body. Particulates, pollutants and debris are unable to pass through the outer wall of the cylindrical body and are thus filtered out.

The sedimentation chamber is for sedimentation of debris which passes through the inlet into the storm water drain pit. This debris may be anything which passes into the storm water drain system e.g. leaves and rubbish that might be left on the street, such as cigarette ends and chewing gum. It is positioned below the lower circular face of the cylindrical filter. Most preferably, the filter is positioned such that water flows through the hollow centre of the cylindrical body and particulates and debris are trapped in the sedimentation chamber.

The sedimentation chamber contains the material that is filtered out of the storm water in the storm water drain pit. Filtered water passes through the outer wall of the cylindrical filter, and the material that is filtered out settles at the bottom of the sedimentation chamber. The sedimentation chamber is emptied at regular intervals. An advantage of the present invention is that the pipe used to extract the rubbish and sludge that accumulates in the sedimentation chamber can be inserted into the sedimentation chamber through the hollow centre of the cylindrical body. This means that the filter does not need to be removed during emptying of the sedimentation chamber. This is very beneficial as storm water drain pits are typically emptied every four to five months. It is therefore advantageous to have a storm water drain pit in which emptying can be carried out efficiently and conveniently. The sedimentation chamber preferably has a height in the range of 200 mm to 360 mm, preferably 260 mm to 300 mm. The sedimentation chamber preferably has a capacity of up to 50 litres, preferably up to 100 litres.

In one embodiment, the sedimentation chamber comprises a reinforced bottom surface. Preferably the bottom surface is reinforced with plastic.

Preferably, the reinforced bottom surface comprises protrusions for centering the sedimented material. This has the advantage of ensuring the sedimented material will flow to the middle and so can be easily removed.

In one embodiment the bottom surface of the sedimentation chamber is perforated, to allow water to infiltrate into the surrounding ground. Preferably, the perforations have a diameter in the range of 90 to 200 microns. This ensures that water can infiltrate the surrounding ground, whilst also ensuring that debris and pollutants do not pass through.

The outlet is for filtered water to be transported out of the storm water drain pit and into the storm water drain system, and eventually to a water collection point. The outlet is positioned above the sedimentation chamber and below the inlet. Preferably the outlet is positioned adjacent the outer wall of the cylindrical body.

The storm water drain pit according to the present invention comprises a separation element for separating the sedimentation chamber from the outlet. The separation element forms the top surface of the sedimentation chamber. Preferably, the separation element extends across the entire cross section of the storm water drain pit and has an aperture which overlaps i.e. is positioned below the lower circular face of the cylindrical body. In this way, the separation element separates the outlet from the sedimentation chamber. This prevents material filtered out of the storm water from passing through the outlet. Storm water passes through the cylindrical body of the drain pit and is filtered through the outer wall of the cylindrical body. Material which is filtered out of the storm water settles in the sedimentation chamber.

In a preferred embodiment, the storm water drain pit according to the present invention comprises at least three rods for fixing the cylindrical body to the guide element and the separation element. The drain pit may comprise three rods, four rods, five rods or more. Preferably the rods are made from plastic or metal, most preferably metal. Preferably the rods extend vertically through the outer wall of the cylindrical body and are attached with nuts to the guide element and the separation element. The rods prevent the cylindrical body of the filter from be moved out of position during heavy rain flow.

In a preferred embodiment, the storm water drain pit according to the present invention comprises a housing. The housing comprises the inlet, guide element, filter, sedimentation chamber, separation element and outlet as defined above. The housing may be made from any material. It may be made from plastic, preferably polypropylene. It may be made from concrete or cast iron. The housing defines a storm water drain pit liner, which may be inserted into a corresponding hole in the ground to form the storm water drain pit. Preferably, the storm water drain pit liner can be inserted into the ground in one step, for ease of instalment.

The housing may be made by extrusion or injection molding. If it is made by extrusion, then the bottom surface i.e. the bottom surface of the sedimentation chamber may be glued onto the extruded shape.

The storm water drain pit according to the present invention can be any shape. Preferably it is cylindrical. The filter may be positioned in the centre of the storm water drain pit, or it may be positioned off-centre. The inlet will be centred with respect to the filter i.e. the inlet is positioned above the filter, so that water flows directly into the filter. The benefit of positioning the filter off-centre, is that it allows the inlet to positioned at the desired location in the ground. Typically inlet with covers for storm water drain pits are positioned as close to the side of the road as possible.

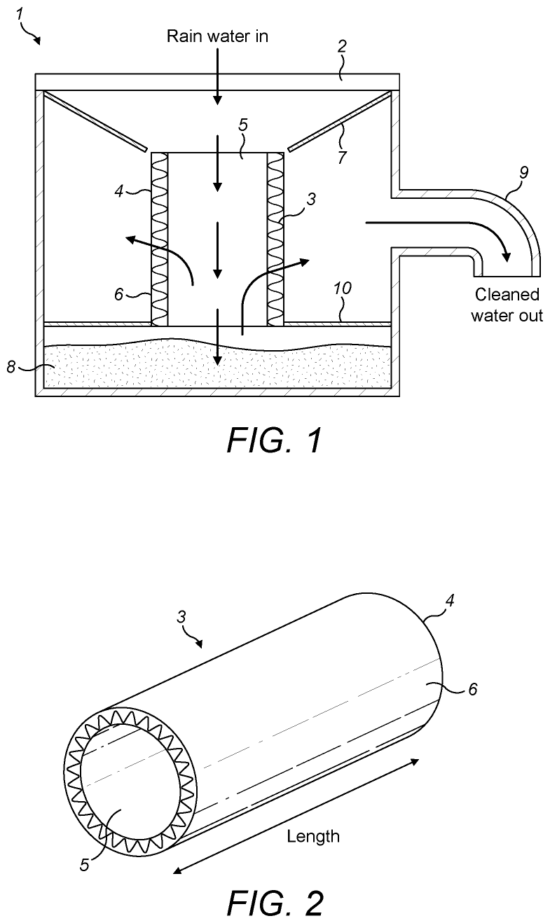

An embodiment of the invention is shown in FIG. 1. FIG. 1 shows a storm water drain pit (1) comprising: an inlet for storm water (2); a filter (3) for removing particles from the storm water, comprising a cylindrical body (4) comprising coherent man-made vitreous fibres (MMVF) bonded with a cured binder composition; wherein the cylindrical body has a hollow centre (5) and an outer wall (6).

FIG. 1 also shows a guide element (7) for guiding water from the inlet into the cylindrical body (5); and a sedimentation chamber (8) for sedimentation of particles from the storm water. In FIG. 1, it can be seen that the cylindrical body is positioned below the inlet and above the sedimentation chamber.

FIG. 1 also shows an outlet (9) for filtered water; and the outlet is positioned above the sedimentation chamber and below the inlet. FIG. 1 shows a separation element (10) for separating the sedimentation chamber from the outlet.

Water, such as rain water, can enter via the inlet into the storm water pit and travels down through the hollow centre of the cylindrical body. The guiding element ensures that the water entering the storm water pit is guided into the cylindrical body. Particles and debris are removed from the water and settle in the sedimentation chamber. The water then passes through the walls of the cylindrical body, and then leaves via the outlet. The separation element and the guiding element ensure that the clean, filtered water and rain water do not mix.

The present invention also relates to a filter for a storm water drain. The invention defines a filter for a storm water drain pit, comprising:

a cylindrical body comprising coherent man-made vitreous fibres (MMVF) bonded with a cured binder composition; wherein the cylindrical body has a hollow centre and an outer wall;
wherein the cylindrical body has a density in the range of 50 to 200 kg/m³, a binder content in the range of 2 to 5 wt % and the outer wall has a circumferential thickness in the range of 2 cm to 20 cm.

The filter may have any of the preferred features discussed above in detail.

An embodiment of the invention is shown in FIG. 2. FIG. 2 shows a filter (3), comprising a cylindrical body (4) which has a hollow centre (5) and an outer wall (6).

The present invention also relates to a storm water drain pit liner comprising:

a housing comprising;
an inlet for storm water;
a filter for removing particles from the storm water, comprising a cylindrical body comprising coherent man-made vitreous fibres (MMVF) bonded with a cured binder composition; wherein the cylindrical body has a hollow centre and an outer wall;
a guide element for guiding water from the inlet into the cylindrical body;
a sedimentation chamber for sedimentation of particles from the storm water, wherein the cylindrical body is positioned below the inlet and above the sedimentation chamber;
an outlet for filtered water; wherein the outlet is positioned above the sedimentation chamber and below the inlet; and
a separation element for separating the sedimentation chamber from the outlet; wherein the cylindrical body has a density in the range of 50 to 200 kg/m³, a binder content in the range of 2 to 5 wt % and the outer wall has a circumferential thickness in the range of 2 cm to 20 cm.

The storm water drain pit liner may comprise any of the preferred features discussed above. The benefit of the storm water drain pit liner is that it can be installed in the ground in one step to form a storm water drain pit.

The present invention also relates to use of a filter for removing particulates from storm water, wherein the filter comprises: a cylindrical body comprising man-made vitreous fibres (MMVF) bonded with a cured binder composition; wherein the cylindrical body has a hollow centre and an outer wall;

wherein the cylindrical body has a density in the range of 50 to 200 kg/m³, a binder content in the range of 2 to 5 wt % and the outer wall has a circumferential thickness in the range of 2 cm to 20 cm.

The filter is as described above. It may have any of the preferred features described above.

The present invention also relates to a method of emptying a storm water drain pit. The storm water drain pit comprises:

an inlet for storm water;
a filter for removing particles from the storm water, comprising a cylindrical body comprising coherent man-made vitreous fibres (MMVF) bonded with a cured binder composition; wherein the cylindrical body has a hollow centre and an outer wall;
a guide element for guiding water from the inlet into the cylindrical body;
a sedimentation chamber for sedimentation of particles from the storm water, wherein the cylindrical body is positioned below the inlet and above the sedimentation chamber;
an outlet for filtered water; wherein the outlet is positioned above the sedimentation chamber and below the inlet; and
a separation element for separating the sedimentation chamber from the outlet;
wherein the cylindrical body has a density in the range of 50 to 200 kg/m³, a binder content in the range of 2 to 5 wt % and the outer wall has a circumferential thickness in the range of 2 cm to 20 cm.

The method of emptying a storm water drain pit comprising the steps:

inserting a storm water drain pit extractor through inlet and the hollow centre of the cylindrical body, and into the sedimentation chamber;
using the storm water drain pit extractor to remove any sediment in the sedimentation chamber; and
removing the storm water drain pit extractor from the sedimentation chamber, hollow centre of the cylindrical body and the inlet.

The present invention also relates to a method of installing a filter into a storm water drain pit, comprising the steps:
(i) inserting a filter into a storm water drain pit; wherein the filter comprises a cylindrical body comprising coherent man-made vitreous fibres (MMVF) bonded with a cured binder composition; wherein the cylindrical body has a hollow centre and an outer wall; wherein the cylindrical body has a density in the range of 50 to 200 kg/m³, a binder content in the range of 2 to 5 wt % and the outer wall has a circumferential thickness in the range of 2 cm to 20 cm.
he filter may have any of the preferred features described above in detail.

The filter for a storm water drain pit according to the present invention may be made by any known method. Mineral wool may be stone wool, glass wool, slag wool, etc. and may be manufactured by producing a mineral melt, spinning fibres from this melt and adding binder to the fibres. The mineral fibres with the binder applied thereon are then formed and shaped into mats of fibres, a fibrous web or the like. Different production methods exist for making annular shaped mineral wool elements, which include cutting, casting or winding of the annular shape, and which are all well-known methods.

One preferred process by which the filter can be made is by casting. The process of producing annular mineral fibre elements (such as pipe sections) in a casting station is a batch process which involves introducing a non-woven mineral fibre web including uncured binder into the casting station. The casting station is provided with casting tools, which are movable from an open position to a closed position. The non-woven mineral fibre web is introduced into the casting tools, when these are in an open position, and the web is received between the opposite casting tools, which casting tools are then moved to a closed position. The mineral fibre web will be formed between the casting tools in the casting station, which define the annular configuration of the mineral wool element produced in the casting station. Afterwards the casting tools are heated for curing the uncured binder to keep the annular shape of the mineral fibre elements. The casting tools are then separated from one another, and the cast annular mineral fibre elements are removed from the casting station.

Another preferred method by which the filter may be made is winding. An annular mineral fibre element (e.g. pipe section or pipe shell) is produced from a thin mat of mineral wool impregnated with a liquid uncured binder. The annular mineral wool element is produced by winding the thin mat of mineral wool onto a rotatable mandrel. The winding includes a plurality of turns onto the mandrel. An endless belt is provided for driving the mandrel and is mounted to engage with the mandrel over a periphery thereof. The thin mat is fed between the endless belt and the mandrel and wound up on the latter one. Preferably, a plurality of pressure rollers is provided to execute pressure on the belt in the direction of the mandrel, and this is geared resiliently so that it can move away under influence of the pressure rollers, as the sleeve grows in diameter or thickness. The thin mat of mineral wool is wound around or onto a mandrel until it has obtained a suitable thickness.

The annular mineral fibre element may be cured on the mandrel or in a curing oven, where the binder is cured to keep the desired form. The annular mineral fibre element can thereafter be cut into the desired size after the mandrel has been removed from same.

Another preferred method by which the filter may be made is cutting. Annular mineral fibre elements can also be produced by making an annular cutting of the mineral fibre element from a larger mineral wool batt. Such a method is described in WO 98/12466.

The most preferred method for making the filter according to the present invention is by winding.

### EXAMPLES

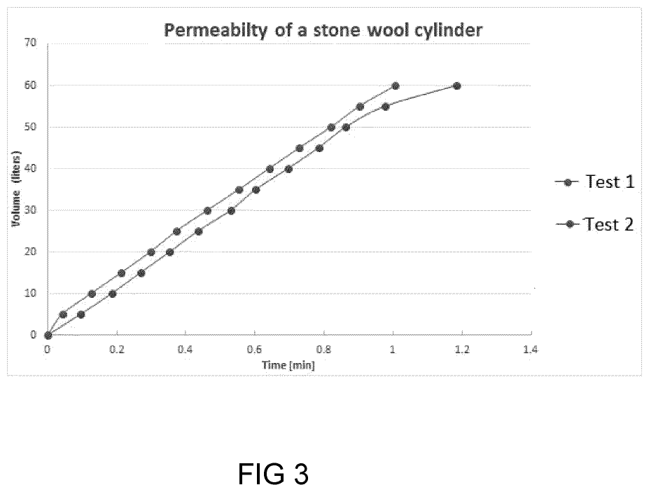

Embodiments according to the present invention were prepared and water permeability was tested. The results are shown in the graph of FIG. 3. A cylindrical filter comprising man-made vitreous fibres cured with a binder composition was prepared. The filter had a density of 120 kg/m³ and a binder content of 3.5 wt %. The filter had a hollow centre and the following dimensions:
inner diameter 14 cm
outer diameter 19 cm
height 30 cm
surface area 1260 cm²
   For the water permeability test, a hose was inserted into the hollow centre of the filter. The water flow from the hose was such that a maximum pressure difference was achieved. The resulting flow rates are shown in FIG. 3. For both Test 1 and Test 2, the flow rate was around 60 litres/minutes.

1. A storm water drain pit (1) comprising:
an inlet (2) for storm water;
a filter (3) for removing particles from the storm water, comprising a cylindrical body (4) comprising coherent man-made vitreous fibres (MMVF) bonded with a cured binder composition; wherein the cylindrical body has a hollow centre (5) and an outer wall (6);
a guide element (7) for guiding water from the inlet into the cylindrical body;
a sedimentation chamber (8) for sedimentation of particles from the storm water, wherein the cylindrical body is positioned below the inlet and above the sedimentation chamber;
an outlet (9) for filtered water; wherein the outlet is positioned above the sedimentation chamber and below the inlet; and
a separation element (10) for separating the sedimentation chamber from the outlet;
wherein the cylindrical body has a density in the range of 50 to 200 kg/m³, a binder content in the range of 2 to 5 wt % and the outer wall has a circumferential thickness in the range of 2 cm to 20 cm.

2. The storm water drain pit according to claim 1, wherein the cylindrical body has a density in the range of 100 to 200 kg/m³ preferably 100 to 160 kg/m³.

3. The storm water drain pit according to claim 1[[ or 2]], wherein the binder content is in the range of 3 to 5 wt %.

4. The storm water drain pit according to claim 1, wherein the cylindrical body has an outer diameter in the range of 5 to 35 cm, preferably 15 to 25 cm, most preferably 19 to 23 cm.

5. The storm water drain pit according to claim 1, wherein the cylindrical body has an inner diameter in the range of 3 to 25 cm, preferably 10 to 22 cm, most preferably 14 to 18 cm.

6. The storm water drain pit according to claim 1, wherein the cylindrical body has a surface area in the range of 500 to 3,000 cm², preferably 750 to 2,750 cm², most preferably 1,250 to 2,500 cm².

7. The storm water drain pit according to claim 1, wherein the length of the cylindrical body is 15 to 55 cm, preferably 20 to 50 cm, most preferably 25 to 45 cm.

8. The storm water drain pit according to claim 1 wherein the cylindrical body is hydrophilic.

9. The storm water drain pit according to claim 1, wherein the cylindrical body is free from oil or substantially free from oil.

10. The storm water drain pit according to claim 1, further comprising a perforated lid for covering the inlet.

11. The storm water drain pit according to claim 1, wherein the sedimentation chamber has a reinforced bottom surface.

12. The storm water drain pit according to claim 1, wherein the sedimentation chamber has a bottom surface comprising perforation for dissipation of water into surrounding ground.

13. The storm water drain pit according to claim 1, further comprising at least three rods for fixing the cylindrical body to the guide element and separation element.

14. The storm water drain pit according to claim 1, wherein the man-made vitreous fibres (MMVF) are selected from ceramic fibres, basalt fibres, slag wool and stone wool.

15. The storm water drain pit according to claim 1, wherein the guide element extends across the entire cross section of the storm water drain pit and has an aperture which is positioned above the upper circular face of the cylindrical body.

16. The storm water drain pit according to claim 1, wherein the inlet is an aperture in the ground, preferably wherein the inlet is positioned directly above the upper circular face of the cylindrical body.

17. A filter (3) for a storm water drain pit, comprising:
a cylindrical body (4) comprising coherent man-made vitreous fibres (MMVF) bonded with a cured binder composition; wherein the cylindrical body has a hollow centre (5) and an outer wall (6);
wherein the cylindrical body has a density in the range of 50 to 200 kg/m³, a binder content in the range of 2 to 5 wt % and the outer wall has a circumferential thickness in the range of 2 cm to 20 cm.

18. Use of a filter (3) for removing particulates from storm water, wherein the filter comprises:
a cylindrical body (4) comprising man-made vitreous fibres (MMVF) bonded with a cured binder composition; wherein the cylindrical body has a hollow centre (5) and an outer wall (6);
wherein the cylindrical body has a density in the range of 50 to 200 kg/m³, a binder content in the range of 2 to 5 wt % and the outer wall has a circumferential thickness in the range of 2 cm to 20 cm.

19. A method of installing a filter into a storm water drain pit, comprising the steps:
inserting a filter (3) into a storm water drain pit; wherein the filter comprises a cylindrical body (4) comprising coherent man-made vitreous fibres (MMVF) bonded with a cured binder composition; wherein the cylindrical body has a hollow centre (5) and an outer wall (6); wherein the cylindrical body has a density in the range of 50 to 200 kg/m³, a binder content in the range of 2 to 5 wt % and the outer wall has a circumferential thickness in the range of 2 cm to 20 cm.

20. A method of emptying a storm water drain pit according to claim 1, comprising the steps:
inserting a storm water drain pit extractor through inlet and the hollow centre of the cylindrical body, and into the sedimentation chamber;
using the storm water drain pit extractor to remove any sediment in the sedimentation chamber; and
removing the storm water drain pit extractor from the sedimentation chamber, hollow centre of the cylindrical body and the inlet.

21. A storm water drain pit liner comprising:
a housing comprising;
an inlet (2) for storm water;
a filter (3) for removing particles from the storm water, comprising a cylindrical body (4) comprising coherent man-made vitreous fibres (MMVF) bonded with a cured binder composition; wherein the cylindrical body has a hollow centre (5) and an outer wall (6);
a guide element (7) for guiding water from the inlet into the cylindrical body;
a sedimentation chamber (8) for sedimentation of particles from the storm water, wherein the cylindrical body is positioned below the inlet and above the sedimentation chamber;
an outlet (9) for filtered water; wherein the outlet is positioned above the sedimentation chamber and below the inlet; and
a separation element (10) for separating the sedimentation chamber from the outlet;
wherein the cylindrical body has a density in the range of 50 to 200 kg/m³, a binder content in the range of 2 to 5 wt % and the outer wall has a circumferential thickness in the range of 2 cm to 20 cm.
